(19) United States
(12) Patent Application Publication
(10) Pub. No.: US 2019/0024520 A1
(43) Pub. Date: Jan. 24, 2019

(54) TURBINE BLADE COOLING

(71) Applicant: Micro Cooling Concepts, Inc., Huntington Beach, CA (US)

(72) Inventors: David S. Underwood, San Jose, CA (US); Geoffrey O. Campbell, Broomfield, CO (US); Jack M. Fryer, Huntington Beach, CA (US)

(21) Appl. No.: 15/659,415

(22) Filed: Jul. 25, 2017

Related U.S. Application Data
(60) Provisional application No. 62/534,505, filed on Jul. 19, 2017.

(51) Int. Cl. F01D 9/04; F01D 25/12

(52) U.S. Cl. CPC F01D 9/041; F01D 25/12; F05D 2220/32; F05D 2230/236; F05D 2260/201; F05D 2260/204; F05D 2240/121

(57) ABSTRACT

A gas turbine engine vane or blade comprises a plurality of micro-structures disposed on an internal surface of the outer wall. The micro-structures may comprise an array of fins having a thickness of less than 0.002″, for example. Cooling air may be impinged upon the surface and routed through at least one flow channel to convectively cool the outer wall. Additionally or alternatively, micro-channels may be disposed along a suction side wall and pressure side wall of the vane or blade to convectively cool the respective walls. An embodiment of a vane or blade in accordance with the present invention may be constructed from a plurality of thin metal foils, stacked and bonded together.

### RELATED APPLICATIONS

This application claims benefit of U.S. Provisional Patent Application No. 62/534,505 filed Jul. 19, 2017, entitled “MICROTEXTURED SURFACES FOR TURBINE BLADE IMPINGEMENT COOLING,” which is incorporated herein by reference in its entirety.

### GOVERNMENT LICENSE RIGHTS

The presented inventions were made with government support under Contract #NNX12CA18C awarded by the National Aeronautics and Space Administration. The government has certain rights in the inventions.

### FIELD

The presented inventions relate generally to gas turbine engines, and more specifically, to internal cooling of blades and vanes subjected to high temperatures inside a gas turbine engine. The inventions have particular advantages for improved turbine engine efficiency, performance, and safety.

### BACKGROUND

Gas turbine engines provide propulsion to all jet aircraft, turbo-props, and helicopters, as well as to some marine vessels. Additionally, some gas turbine engines are used to convert natural gas to electricity to supply a significant fraction of U.S. electrical power.

Most gas turbine engines operate in a similar manner, that is, by combusting fuel in a stream of compressed air to extract energy. Essentially, a gas turbine engine has a compressor in fluid communication with a turbine with a combustor therebetween. The compressor and the turbine may have a series of stages, each associated with varying properties such as diameter, blade angle, total pressure, etc. Ambient air is received at an inlet of the compressor before being compressed and discharged into the combustor at a substantially higher pressure and temperature. It is mixed with fuel in the combustor and burned, thereby increasing the temperature and velocity of combustion gases (i.e., gases exiting the combustor). The hot combustion gases are routed through the turbine blades causing them to rotate such that mechanical shaft power may be extracted to drive a shaft, propeller or fan (including the compressor, for example). Excess exhaust pressure can be used to provide thrust.

The efficiency and power output of a gas turbine engine depends on many factors including, but not limited to, the size, pressure and temperature levels achieved. Higher operating temperatures are desired, but material limitations restrict operating temperatures to prevent cracking, softening, or other mechanical failures of engine components. Therefore, improved cooling schemes are desired to allow for higher operating temperatures without material failures.

Gas turbine engine technology is constantly challenged to operate at higher efficiencies, leading to a push towards stoichiometric combustion and ever higher combustor outlet temperatures. In a modern gas turbine engine, temperatures can exceed the vane (e.g., nozzle guide vane) material limits by 600° F. or more, necessitating internal convective cooling and film-cooling schemes in addition to the use of thermal barrier coatings. Internal convective cooling is often inadequate alone, particularly in the stagnation region of the vane (e.g., the area around the stagnation point, where combustion gas flow is bifurcated around the vane and a portion of the flow is at least temporarily brought to rest). Both internal and film-cooling approaches can lead to significant performance penalties in the engine, due to thermal mixing (e.g., cooling air is dumped into the hot stream of combustion gases) and total pressure losses (e.g., siphoning high pressure cooling air from the compressor and dumping it into the core flow without extracting useful work).

In early gas turbine engines, convection cooling was extensively used in a manner in which the rotating blade acted essentially as a single-pass cross-flow heat exchanger. Compressed air would flow radially through internal passages in one-direction from root of a blade to tip, propelled by pressure differences and centrifugal force, thereby removing heat convectively transferred to the blade. Improvements in modern manufacturing technology means that it may now be possible to create a serpentine web of cooling channels within a blade or vane, thereby effectively turning the system into a multi-pass heat exchanger with improved cooling capabilities. Furthermore, cooling air may also be exhausted through small exhaust ports onto the external airfoil surface to form a thin protective layer of cooling air around the vane, hence the name “film-cooling.”

Currently, turbine components are typically cooled by circulating cooling air (i.e., air that is cooler than the combustion gases) from the compressor through internal passages located inside the given component. The circulated cooling air may provide a convective cooling effect as it passes through the internal passages of the component. The cooling air is heated as it cools the component (although it is still cooler than the combustion gases) and may then be discharged through small exhaust ports in an exterior surface of the component to form a film-cooling effect. In a modern gas turbine engine, about 20% of the air from the compressor may be bled off for cooling and sealing related to vanes and turbine blades. For example, vanes may utilize cooling air from the compressor for film-cooling. Additionally, a cooling system may be used to prevent any hot core flow gases from flowing over blade-attachment discs or to control tip clearances between turbine blades and an outer casing (e.g., active clearance control).

Typically, the first stage turbine vanes of a gas turbine engine are exposed to the highest temperatures as they are nearest the combustor on the downstream side. The temperature may then decrease in later turbine stages due to dilution of hot combustion gases with cooling air, relative velocity effects and power extraction (e.g., gas expansion causes a drop in temperature). One challenge associated with cooling these critical vanes is that the pressure differential between the cooling air and the hot combustion gases which flow around the airfoil of the vane needs to be minimal to maintain efficiency. Cooling air for a first stage turbine vane may be received from the compressor and routed internally through the vane before being fed through an exhaust port (e.g., a film-cooling hole) in the vane and into the core flow (the primary path through the engine including the compressor, combustor, and turbine). Combustion gases may also be routed to (or near) the same exhaust port from an external side of the vane in the core flow. In this regard, if the combustion gas pressure were higher than the pressure of cooling air routed from the compressor, the cooling air would fail to exhaust from the vane and hot combustion gases would enter the vane through the exhaust ports. This would be undesirable as it would subject the internal passages of the vane to high temperatures and stall the cooling system, likely leading to material failure caused by overheating. During normal operation of a gas turbine engine, however, the laws of thermodynamics require that, due to combustion inefficiencies, a small pressure drop occurs in the combustor such that cooling air routed from the compressor through a bypass (e.g., around the combustor) maintains a higher pressure than the combustion gases exiting the combustor. This means that the core flow pressure at the first row of vanes in the turbine directly after the combustor must be lower than at the exit of the final stage of the compressor. It is this pressure difference that is used to drive cooling air through internal passages of the vanes. In this respect, improvements in combustor design over the last several years have been both an advantage and a disadvantage for cooling engineers. Improvements in compressor and combustor designs have led to higher compressor pressure ratios and lower combustor pressure losses, respectively, such that more force is available to drive cooling air to cool the hotter aft parts of the engine. On the other hand, with increasing compression ratios the air within the compressor naturally reaches higher exit temperatures (e.g., around 900K prior to combustion) reducing the effect that the cooling air has on the turbine vanes. Furthermore, cooling air is expensive from an efficiency point of view because it would be ideal to “waste” as little air from the compressor as possible for cooling purposes so that it can be preserved for combustion and/or thrust.

Generally, the efficiency of a convective cooling system is measured by the ratio of actual temperature increase of the cooling air to the theoretical maximum temperature increase possible. In this regard, a slight temperature increase in the cooling air indicates low cooling efficiency whereas a temperature increase up to the temperature of the component to be cooled (theoretical maximum) indicates 100% cooling efficiency. In previous methods of cooling a turbine vane which utilize a single impingement point, cooling air is directed to impinge on a surface and then is exhausted. This brief interface between the cooling air and the heated component limits the amount of heating capacity used and thereby limits cooling efficiency.

Accordingly, prior art methods fail to effectively cool vanes and blades of jet turbine engines above current operating temperatures and compromise engine efficiency. It would be advantageous to develop a cooling system and method with improved cooling such that operating temperatures and associated efficiencies could be increased.

### SUMMARY

The specific power of a gas turbine engine generally increases with inlet temperature. In the last 25 years, however, maximum material temperature limitations have significantly hindered progress toward operating temperature increases. Improved cooling of the engine blades and vanes may allow higher inlet temperatures without stressing materials beyond temperature limitations.

An important metric of cooling turbine vanes and blades is the thermal resistance (a measure of the ease with which the vane can dissipate heat from a surface). As will be appreciated, the thermal resistance of a vane is related to the thermal conductivity of the material forming the vane. However, the thermal resistance is also related to the physical configuration of internal passages in the vane used for cooling and operating conditions. By way of example, thermal resistance of a vane will change based on the design of the internal passages, the thickness of material separating the internal passages from other components of the vane, the flow rate of air through the internal passages, heat load, etc. An embodiment of the presented inventions includes placement of micro-structures in regions of high heat exposure in vanes and blades to improve the thermal resistance thereof.

The disclosed turbine vane cooling concepts provide enhanced internal cooling effectiveness via the use of micro-structured impingement surfaces in the hottest regions of a turbine vane (e.g., stagnation point and suction side heating peak) which may be combined with micro-channel cooling of vane side walls, eliminating the need for film-cooling. Performance degradations due to thermal mixing and total pressure losses can be mitigated by reducing the amount of cooling air introduced into the core flow through the first few turbine stages. This can be achieved by improving internal cooling effectiveness, thereby reducing or eliminating the need for film-cooling, and relying solely, or more heavily, on internal cooling. It should be noted that although higher air flow rates through cooling systems result in better heat transfer, the increase typically reduces engine efficiency (e.g., by bleeding pressurized cooling air from the core flow). Therefore, in conventional systems, high flow rates are common but may result in sacrificing performance and efficiencies. The concepts disclosed herein may reduce the needed air flow rate resulting in improved efficiency over conventional systems. Total pressure losses may also be limited by minimizing perturbations in the combustion gas flow caused by exhausting cooling air into the core flow.

An embodiment of the presented inventions incorporates flow channel cooling techniques in a gas turbine engine vane. Notably, as used herein, a flow channel may refer to any internal passage in a turbine vane which serves as a conduit to move cooling air through a vane within a spanwise cross-sectional plane. Micro-channel, as that term is used herein, generally refers to a flow channel disposed adjacent to a suction-side wall, pressure-side wall, or trailing edge and typically do not contain micro-structures, although in certain embodiments they may. Generally, reference to a flow channel refers to an internal passage containing micro-structures disposed adjacent to the leading edge region.

One form of constructing a vane having a flow channel cooling system includes a plurality of thin plates or foils which may be laminated together to form a block. Often, the foils may be thin metallic strips. Apertures, recesses, and other design features may be cut through or into the foils at various locations as needed. For example, apertures may be cut through the foils at a common location at opposite ends of recessed portions such that, when the stack of foils is laminated, the apertures align to form air distribution plenums though the stack in a spanwise direction (typically normal to the face of each foil) and recessed portions form flow channels within a spanwise cross-sectional plane, connecting air distribution plenums. Additionally or alternatively, apertures may also be cut into some foils and omitted from others such that when stacked, apertures on adjacent foils may be combined to form flow channels of a greater width than just a single foil. Such a flow channel may be capped on each end by a foil or foils having a solid surface in the respective area.

Each of the air distribution plenums may essentially be considered a conduit which passes through at least a portion of the vane to supply (i.e., inlet plenum) or receive (i.e., outlet plenum) cooling air to and from flow channels, respectively. The air distribution plenums may be connected via a plurality of shallow channels (i.e., flow channels) formed from recessed portions, apertures and/or walls formed in or defined by the foils. It should be appreciated that, in some embodiments such internal passages may be formed into the vane after the foils are laminated/bonded. That is, internal passages may be milled or otherwise formed into the vane and in some embodiments, a vane may be 3D printed such that the air distribution plenums, flow channels, and/or micro-structures are formed in each layer of the vane as it is built.

Recessed portions may be etched into at least one face of a foil through mechanical or chemical means. For example, although various depths of recessed portions and various thicknesses of foils are envisaged, the recessed portions may have a shallow dimension on the order of 10-50 microns deep prior to lamination of a 0.002″ thick foil. The air distribution plenums may be attached to a manifold on one or both ends of the vane. The manifolds may be operative to circulate cooling air through the air distribution plenums and the flow channels. Notably, more complex geometries and/or branching networks of internal passages may be utilized and the embodiments described herein are exemplary in nature.

The thicknesses of the foils may be equal or may differ from one foil to another or even within a single foil. For instance, to tailor a surface such as a leading edge to have desired thermal properties (e.g., increased cooling in one area with reduced weight in another), it may be desirable to use differing thicknesses to create micro-structures and flow channels having differing properties. Furthermore, the foils may be of one-piece construction or may be otherwise configured, for example, as multi-piece foils that collectively define the internal passages and other features.

Once the foils are formed, they may be disposed in a stack such that the flow channels are aligned. Each foil may have alignment holes configured to receive an alignment rod during stacking to ensure proper alignment of the flow channels. Once aligned, the mating faces of adjacent foils may be laminated or bonded together. In one embodiment, such lamination may be performed in a diffusion bonding process. In some embodiments, other processes such as brazing or soldering may be utilized.

It is contemplated that vanes in accordance with an embodiment of the presented inventions may be fabricated from Hastelloy X, a high-temperature super alloy. It is noted that any suitable material may be used instead of or in addition to Hastelloy X. Some non-limiting examples include Inconel MA754, Haynes 230, Waspaloy, or Inconel 617. Hastelloy X may be preferable for applications utilizing diffusion bonding manufacturing techniques in order to prevent delamination.

In accordance with an embodiment of the presented inventions, a micro-structured impingement surface may comprise a plurality of fins forming a finned array. One or more of such fins may be etched or cut into one or more foils and may serve to increase the surface area available for convective cooling on a high temperature region of a vane. Numerous (e.g., hundreds or thousands) fins may be disposed on an internal impingement surface of an outer wall of a vane in the leading edge region depending, for example, on the physical dimensions of the vane. As cooling air is circulated over the fins, heat may be transferred from the fins and into the air, thereby cooling the otherwise temperature vulnerable leading edge region(s) of the vane.

In order to maximize cooling for micro-structured impingement surfaces, it may be desirable to utilize a small fin size with a high velocity of impingement cooling air. However, this may cause an undesirable drop in air pressure. Larger fins may cause a reduction in the velocity of cooling air circulating through the impingement region thereby retaining air pressure but may reduce cooling effectiveness due to the lower air velocities. Therefore, a balance may be struck between pressure, velocity, and cooling effectiveness. In other words, cooling effectiveness must be balanced against overall engine efficiencies.

An impingement cooling region of a vane may be segmented into multiple impingement cooling regions. For example, a dual region design may be utilized such that an inside surface of each heating peak (i.e., stagnation point or suction-side heating peak) is disposed within an impingement cooling region (i.e., two regions with flow entering between the peaks and wrapping around toward the sides of the vane in opposite directions). Such a segmented design may promote higher cooling air pressures or velocities and lower cooling air temperatures at the heating peaks as compared to a single channel design. In order to cool the surface of a vane downstream of an impingement region, micro-channels may be incorporated into the vane side walls in areas where fins or other micro-structures are omitted. In this regard, regions of a vane which are not subjected to temperatures as extreme as those near the leading edge may nonetheless be internally cooled by convection. Each foil may comprise a portion of such micro-channels or certain foils (e.g., every other foil, every 6^{th} foil, etc.) may comprise a solid portion in the side wall regions which serves to separate micro-channels disposed in adjacent foils.

In an embodiment, a first inlet plenum may supply cooling air to an impingement region(s) containing micro-structures. Furthermore, to eliminate the need to exhaust cooling air into the core flow, after the cooling air has provided impingement cooling, the cooling circuitry may allow for side wall cooling via a second inlet plenum that feeds cooling air into micro-channels, for example, near a midpoint of a side of a vane. Such second inlet plenum positioning may offer the benefits of reducing the flow rate in the flow channels and reducing the flow path length for the cooling air as compared to a design utilizing a single inlet plenum. Inlet flow may enter at a midpoint of a micro-channel and split, with a portion (e.g., half) of the flow traveling upstream toward a leading edge region and the remainder of the flow traveling downstream toward the vane trailing edge. Alternatively, the second inlet plenum and micro-channels may be positioned such that all of the suction-side wall or pressure-side wall cooling air is routed in a single direction along the side wall(s).

To reiterate, in an embodiment of the presented inventions, the leading edge may be cooled by cooling air impinging the internal surface of the leading edge at some point between the stagnation point and the suction-side heating peak. A portion of the cooling air may travel through a finned array (i.e., a plurality of fins) in a leading edge flow channel toward the stagnation point, while the remaining cooling air may travel through another finned array toward the suction-side heating peak. The flow from both finned arrays may exit through outlet plenums which may be aft of the finned regions. It is also contemplated that multiple cooling air flows may be combined and exhausted through a single outlet plenum. A second inlet plenum may introduce cooling air approximately midway down the chord of the vane with flow traveling both forward and aft on one or both side walls of the vane through micro-channels, and exiting through an outlet plenum, the same or different than the outlet plenum utilized to exhaust the flow from the finned array(s). As an example, micro-channels cooling the side walls may be approximately 6 mils high in the spanwise direction, with 6 mil thick solid regions (fins) on either side, although these dimensions should not be considered limiting as micro-channels may be smaller or larger. Air distribution plenums described herein may run the entire span of a vane, as may finned regions. Alternatively, various features described herein such as inlet plenums, outlet plenums, finned regions, etc., may be disposed only in a targeted region or regions of a vane associated with high temperatures.

In another embodiment, cooling air may impinge the internal surface of the leading edge at a point directly corresponding to the stagnation point. A portion of the cooling air may travel through a finned array in a leading edge flow channel toward an outlet plenum, while the remaining cooling air may travel through another finned array toward the same, or a different, outlet plenum. In this regard, a vane design may prevent a suction-side heating peak and therefore, the stagnation point may be the sole critical heating peak requiring improved cooling.

The general cooling principles outlined herein may be combined with other cooling techniques. For example, cooling air may be exhausted through film-cooling exhaust ports after passing through a finned array in the leading edge flow channel or a micro-channel instead of routed through an outlet line in a manifold. In such an arrangement, the mass flow of the cooling air discharged into the core flow of the turbine may be reduced in comparison to prior film-cooling arrangements.

The presented inventions provide several advantages over prior art solutions including but not limited to: 1) an ability to operate at current engine operating temperatures using only internal cooling, thereby eliminating film-cooling and the associated aerodynamic penalties; 2) turbine inlet temperature capability may be increased by 350° F. or more during operational conditions, while eliminating film-cooling; and 3) vane leading edge cooling efficiency may be increased more than 20% when compared to conventional vane performance. These improvements may yield significant advances in fuel efficiency. The benefits stemming therefrom may include: 1) potential cost savings that presently correspond to several billion dollars worldwide, 2) improved efficiency directly translating into lower CO2 emissions and decreasing the impact of CO2 emissions on the environment (additionally, more complete combustion will occur at higher inlet temperatures resulting in lower emissions of SOx and NOx), 3) increased engine life allowing airlines to increase the mean time before overhaul (MTBO) which may translate into more uptime hours, and 4) increased turbine reliability allowing airlines to operate with a higher reliability factor which may translate into more on-time departures and fewer hours of out-of-service repairs.

Numerous additional features and advantages of the presented inventions will become apparent to those skilled in the art upon consideration of the embodiment descriptions provided hereinbelow.

### BRIEF DESCRIPTION OF THE DRAWINGS

FIG. 1 is a cross-section view of typical air flow through a gas turbine engine.

FIG. 2 is a cross-section view of a gas turbine engine showing film-cooling exhaust ports in turbine blades and vanes.

FIG. 3 is a cross-section view of an exemplary nozzle guide vane or other vane.

FIG. 4 is a cross-section view of a vane illustrating an exemplary embodiment of cooling air flow paths.

FIG. 5 illustrates three embodiments of micro-structures that may be formed on a surface of a vane or blade.

FIG. 6 illustrates various embodiments of interior surfaces of a vane or blade with or without micro-structures.

FIG. 7A illustrates an embodiment of a metal foil for impingement cooling including micro-channel side wall cooling.

FIG. 7B illustrates an embodiment of a stackable foil for impingement cooling.

FIG. 8A illustrates an embodiment of full thickness fins on a foil.

FIG. 8B illustrates an embodiment of half-etched fins on a foil.

FIG. 9 illustrates a partially-exploded view of a vane or blade constructed of stackable foils.

FIG. 10A illustrates flow channel interfaces in an embodiment of a vane or blade.

FIG. 10B illustrates air distribution plenums in an embodiment of a vane or blade.

FIG. 11A illustrates an embodiment of a vane or blade disposed between two manifolds.

FIG. 11B illustrates an exploded view of a vane or blade disposed between two manifolds.

FIG. 12 illustrates an alternative embodiment of a stackable foil having micro-structures for impingement cooling.

FIG. 13 illustrates an embodiment of a stackable foil for impingement cooling which utilizes film-cooling

### DETAILED DESCRIPTION

The following description is not intended to limit the inventions to the forms disclosed herein. Consequently, variations and modifications commensurate with the following teachings, skill and knowledge of the relevant art, are within the scope of the presented inventions. The embodiments described herein are further intended to explain modes known of practicing the inventions and to enable others skilled in the art to utilize the inventions in such, or other embodiments and with various modifications required by the particular application(s) or use(s) of the presented inventions. Although the term “vane” is frequently used herein, and the features and functionality may be primarily directed to turbine vanes (i.e., stators), it should be appreciated that the internal cooling concepts described may be equally applicable to a rotating turbine blade or other gas turbine engine component and use of the term “vane” should not be interpreted as limiting the scope of this disclosure. Rather, the word vane is used because nozzle guide vanes disposed nearest the combustor are often subjected to the most extreme heat and may be prone to failure, thus making the concepts described herein pertinent. Nevertheless, the concepts described herein may be equally applicable to other engine components and the words “vane,” “stator,” “blade,” etc. may be used interchangeably and may refer to any gas turbine engine component subjected to high temperatures which require some type of cooling system.

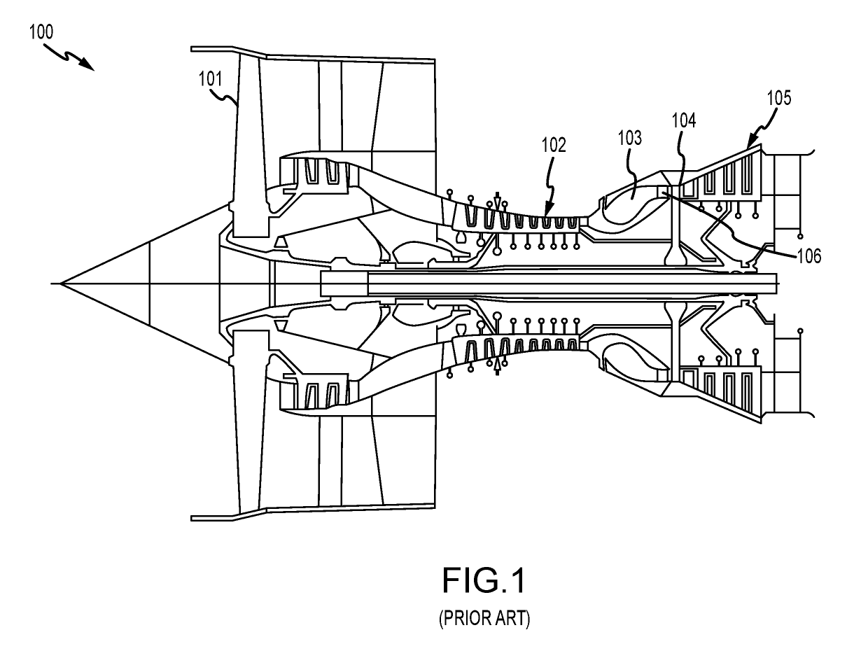

FIG. 1 shows a cross-sectional view of a typical flow path of cooling air through a gas turbine engine 100 as known in the prior art. Ambient air enters through the fan 101 and moves through the low pressure region toward the compressor 102. A series of rotating blades and/or vanes may progressively increase the pressure of the air prior to injection into the combustor 103. A combustor 103 may comprise a plurality of combustion chambers. Fuel is added to the high pressure air and ignited inside the combustor 103. High temperature combustion gases are routed through a series of nozzle guide vanes 106. The combustion gases then flow through the various stages of the high pressure turbine 104 and low pressure turbine 105. The movement of the combustion gases through the turbine stages 104, 105 rotate the various turbine blades which in turn rotate a drive shaft(s) powering the compressor 102 and/or fan 101.

The highest temperatures in a gas turbine engine are commonly encountered at the nozzle guide vanes 106 and high pressure turbine components 104. These high temperatures are typically a critical limiting factor in the operation of a gas turbine engine due to material limitations. That is to say, it is desired in the field to utilize metals or other materials with exceptional temperature tolerance, to improve cooling systems, or both. Many gas turbine engines must be throttled back from their full power generation capacity so as to avoid extreme temperatures which may cause material failure such as cracking or softening in the nozzle guide vanes 106 and high pressure turbine 104 components. Improved materials of construction or cooling of these critical features may allow gas turbine engines to operate at higher temperatures yielding improved performance and efficiency.

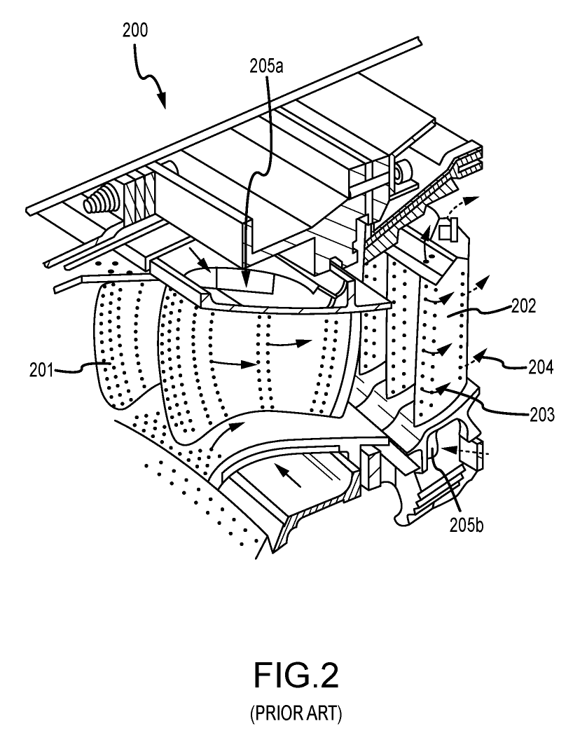

FIG. 2 shows a cut-away view of a turbine portion 200 of a gas turbine engine as is known in the art. Shown is a row of nozzle guide vanes 201 adjacent to a row of turbine blades 202. Various components illustrated include film-cooling exhaust ports through which cooling air may be exhausted. Cooling air 203 may be routed from the compressor through a bypass which avoids the combustor. This cooling air may then enter into a nozzle guide vane 201 through air distribution plenum 205a or turbine blade 202 (or other component) through air distribution plenum 205b connected to a manifold. The cooling air may then be exhausted through a plurality of exhaust ports to cool the vane 201 or blade 202 by forming a film of protective air which partially shields the outer surface of the vane 201 or blade 202 from the high temperature combustion gases. Typically, high pressure cooling air 203 is utilized in high temperature areas to maximize cooling while low pressure cooling air 204 may be used in areas which require cooling, but to a lesser extent than those areas requiring high pressure cooling air 203. It should be appreciated that all cooling air 203, 204 circulated through the engine components may be of similar pressure. Exhausting high pressure cooling air into the stream of combustion gases may cause an undesirable drop in efficiency such that it is preferable to use lower pressure cooling air when possible. In certain instances, it may be desirable to avoid exhausting any cooling air into the stream of combustion gases to maintain engine efficiency.

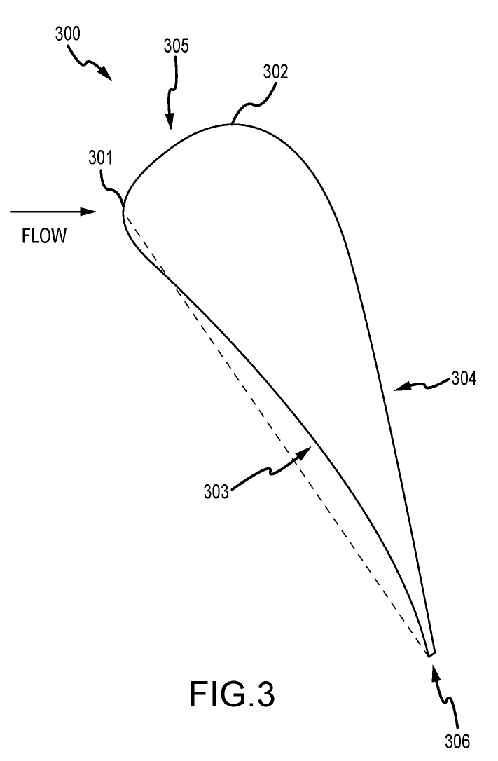

FIG. 3 is a schematic cross-sectional view of a nozzle guide vane, a turbine blade, or other similar component 300. The direction of flow of combustion gases through a gas turbine results in initial contact with the vane at the stagnation point 301 of the leading edge region 305. The combustion gas flow is bifurcated at the stagnation point 301 with a portion flowing around the suction-side 304 of the vane and a portion flowing around the pressure-side 303 of the vane before merging at the trailing edge 306. The dashed line illustrated in FIG. 3 indicates a chord length between the stagnation point 301 and the trailing edge 306.

Typically, the highest temperatures experienced on the outer surface of a vane 300 occur in the vicinity of the stagnation point 301 due to the flow being brought to rest at the stagnation point 301. Another region of high temperatures may also form at a suction-side heating peak location 302 due to the flow of combustion gases, and their associated boundary layer, over the surface of the vane 300 transitioning from laminar to turbulent, thereby increasing the external convective heat transfer coefficient.

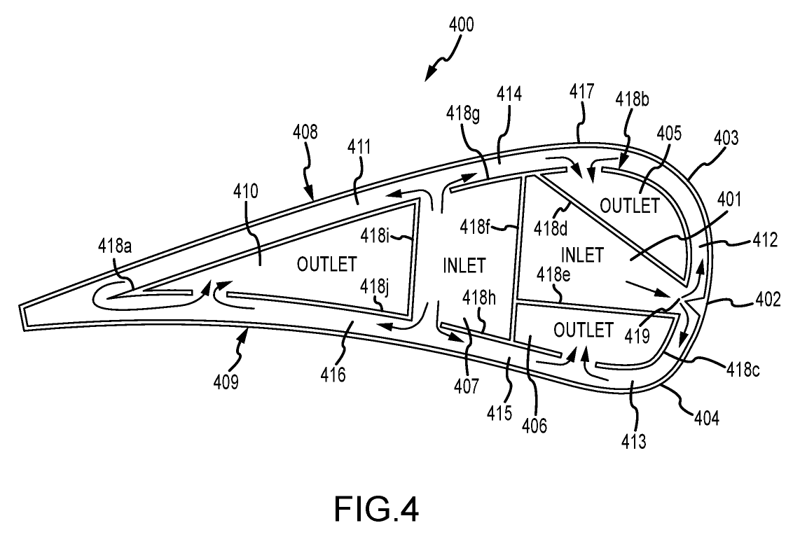

FIG. 4 illustrates one embodiment of routing cooling air through a vane 400 to effectuate impingement cooling. As shown, the vane is defined by an outer wall 417 in the shape of an air foil. In the illustrated embodiment, the numerous internal walls 418a-j within the periphery of the outer wall define air supply (e.g., inlet) and exhaust (e.g., outlet) plenums 401, 405, 406, 407, 410, flow channels 412, 413 and micro-channels 411, 414, 415, 416. The inventors have recognized that previous impingement cooling designs have been insufficient to meet cooling demands of gas turbine engine parts. Specifically, impingement cooling has failed to independently meet cooling needs along the leading edges of vanes, particularly at the stagnation point and suction-side heating peak. Therefore, previous designs have generally included film-cooling in addition to impingement cooling. The inventors have further recognized that the total surface area of the interior surface of the outer wall may be increased, thereby increasing convective cooling to reduce or eliminate the need for film-cooling. A reduction in the volume of bleed air needed for film-cooling may improve engine efficiency. In accordance with an embodiment of the presented inventions, micro-structures may be provided on at least a portion (e.g., leading edge region) of an interior surface of an outer wall of a vane to increase surface area and improve convective cooling along the leading edge cooling air flow channel 412, 413.

Cooling air may be circulated internally in a vane 400 to draw heat away from the outer wall 417 which may otherwise become overheated in the absence of impingement cooling and/or film-cooling. Cooling air may enter a given stratum of the vane 400 through a first inlet plenum 401 which passes longitudinally through at least a portion of the vane 400 to distribute the cooling air throughout the vane 400. The cooling air may be pressurized to promote rapid air flow for improved cooling. In the illustrated embodiment, the cooling air may exit the first inlet plenum through an impingement nozzle 419 and impinge upon a wedge 402 which bifurcates the cooling air flow with a portion flowing into a flow channel 412 which passes across the suction-side heating peak 403 and a portion flowing into a flow channel 413 which passes across the stagnation point 404. The flow channels 412, 413 are defined by the inner surface of the outer wall 417 and an outer surface of one or more inner walls 418b, 418c. The wedge 402 prevents the formation of a stagnation point on the internal side of the outer wall of the vane 400 and encourages smooth flow entry into the flow channels 412, 413. The wedge 402 may also define the impingement angle of the cooling air flow upon the outer wall to maintain cooling air flow velocity, wherein a wide wedge may translate to higher velocities through the flow channels than a narrow wedge. However, it will be appreciated that the wedge 402 is not required. As cooling air passes across the inner surface of the outer wall 417 of the vane 400, it convectively draws heat from the outer wall 417 and carries it away toward an outlet. Heated cooling air may be circulated from flow channel 412 toward outlet plenum 405 and from flow channel 413 toward outlet plenum 406.

Similarly, cooling air may also be brought into circulation through a second inlet plenum 407 and directed to cool various targeted surfaces. For example, a portion of the cooling air may be circulated through micro-channel 414 to cool the suction-side outer wall 408 before being exhausted through outlet plenum 405 and a portion of the cooling air may be circulated through micro-channel 415 to cool the pressure-side outer wall 409 before being exhausted through outlet plenum 406. A portion of the cooling air entering through inlet plenum 407 may also be directed rearward. For example, a portion of the cooling air may be circulated through micro-channel 411 to cool the suction-side outer wall 408 and a portion of the cooling air may be circulated through micro-channel 416 to cool the pressure-side outer wall 409 before being exhausted through outlet plenum 410. It should be appreciated that the described embodiment is only exemplary in nature and any combination of flow channels, micro-channels, inlet plenums, and outlet plenums may be utilized. For example, one inlet plenum and one outlet plenum may be used or three inlet plenums and two outlet plenums. The number of inlet and/or outlet plenums that may be incorporated into a design may be related to a desired engine operating temperature, a volume of cooling air needed to sufficiently cool the vane given the desired engine operating temperature, the heat capacity of the cooling air, the mass flow rate of the cooling air, and the surface area available for impingement cooling, etc. It should be appreciated that having multiple inlet plenums disposed at different locations may allow for unheated cooling air to be directed to the highest temperature areas of the vane more effectively than if only a single inlet plenum were used and the cooling air was circulated around the entirety of the inner surface of the outer wall without the introduction of additional cooling air in secondary locations.

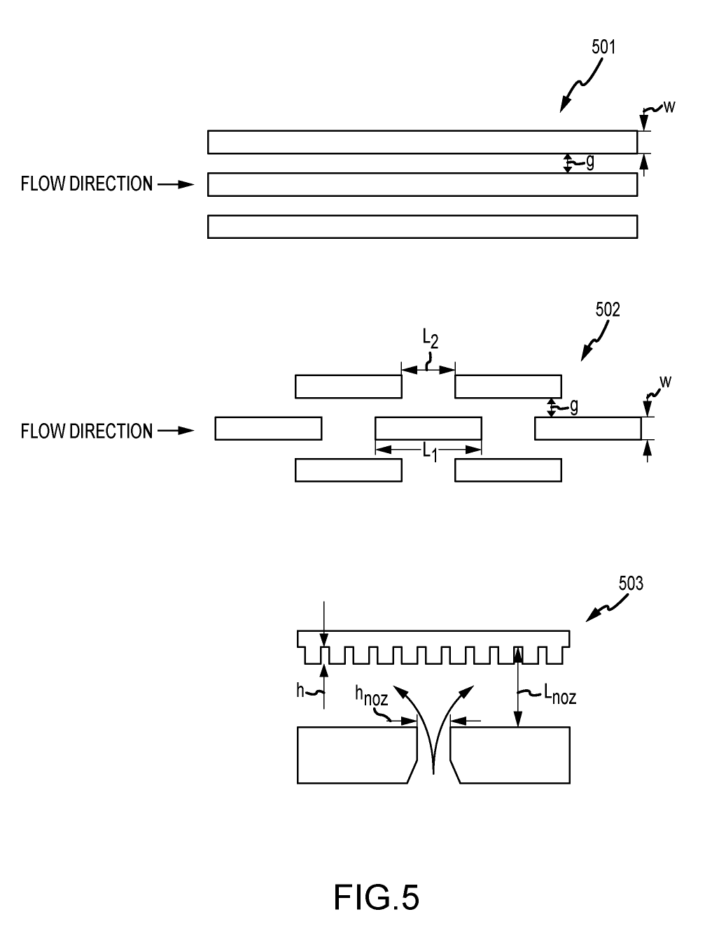

FIG. 5 illustrates three non-limiting exemplary embodiments of micro-structures (i.e., grooves 501, fins 502, and micro-texturing 503) that may be formed on the inside surface of the outer wall of a vane, each of which is discussed below. One important characteristic that these micro-structures have in common is that they are configured to increase the surface area available for cooling of the surface on which they are disposed beyond that of a smooth surface of similar height and width. In some embodiments, it may be desirable to vary the dimensions of the micro-structures in certain regions of the impingement area to optimize certain properties (e.g., pressure, velocity, cooling, contact area, etc.). Additionally or alternatively, it may be desirable to provide micro-structures having uniform dimensions.

### Grooves

A micro-structured surface may comprise longitudinal grooves (i.e., running in the direction of cooling air flow). It is contemplated that grooves need not run longitudinally but may provide less resistance to air flow. In either regard, the grooves may provide additional impingement surface area equal to the area of the two side walls which form each groove. For example, a given area of a wall (e.g., 1 square inch) with grooves having a depth equal to their width (w), and having a spacing (g) equal to their width, would provide approximately twice as much surface area (e.g., 2 square inches) as a smooth surface of the same area (i.e., 1 square inch). Each groove may be of any suitable height, for example, 0.1 mm or 5 mm. Similarly, spacing between grooves (g) may be modified to achieve desired cooling air flow and cooling properties.

### Fins

Fins, as discussed herein, are protrusions extending from the surface of a wall. Fins may generally be any suitable shape such as round, flat, square, etc. In FIG. 5, fins are shown as being substantially flat so as to have a low profile (w) in the direction of cooling air flow. A finned array may be aligned longitudinally in rows to allow for an unobstructed flow path between rows, as shown in FIG. 5. Alternatively, fins may be offset to increase resistance to cooling air flow which may increase flow path length, thereby increasing heat transfer. Similarly, lateral spacing between fins (g) may be adjusted to modify air flow properties. Fin heights (in a direction perpendicular to the page in FIG. 5) may vary, for example; they may be longer in areas requiring greater surface area for increased heat transfer. Fins may be of any suitable height based on the geometry of a particular vane. The gap between the bases of adjacent fins (L₂) may be consistent throughout the finned array or may be variable to achieve desired air flow properties. Similarly, each fin may have a similar base width (L₁) or the base widths may vary. Due to the curved nature of the impingement surface (e.g., inner surface of the outer wall of a vane near the leading edge) the tips of the fins may be smaller in size as height increases. That is to say, the dimension L₁ may be greater at the base of a fin than at the tip of the fin to allow sufficient L₂ spacing for cooling air flow.

The inventors have determined that L₂ values smaller than the L₁ dimension may increase the pressure drop observed from the inlet nozzle to the exit of a leading edge flow channel, leading to lower surface velocities and higher maximum vane material temperatures. Moreover, the pressure drop through fins is less than that associated with a similar groove design.

### Micro-Texturing

An impingement surface may be micro-textured in lieu of or in addition to fins, grooves, etc. Micro-texturing may comprise a chemical or mechanical process of roughening a surface to increase the available surface area.

### Shroud

A micro-structured surface may comprise a flow confinement shroud (not shown in FIG. 5) which may approximately follow the curvature of the outer wall to define an outer limit of the flow channel in which the micro-structures are disposed. A shroud may cover all or only a portion of a flow channel. A shroud may be disposed along the top of the micro-structures (e.g., fins or grooves), may be offset therefrom (i.e., leaving a gap between the tips of the fins and the shroud), or both. A shroud may serve to confine the cooling air flow within the flow channel (by forming a confinement or inner wall) which may improve cooling due to minimized air mass flow bypassing the micro-structures. Furthermore, a shroud may be effective to maintain spacing between adjacent grooves or fins to maximize cooling air flow and structurally reinforce the grooves or fins to prevent damage which may occur from vibrations and jolts which may be experienced in a gas turbine engine. Further still, a shroud may provide additional surface area to transfer heat from the vane into the cooling air.

The pressure drops observed in a flow channel are the largest when the fins extend all the way to the confinement wall and the channel is the smallest. As would be expected, tests have shown that the best heat transfer occurs when the cooling air flow velocity is maximized. Thus observation of the velocity, temperature, and pressure contours indicated that it may be desirable for fins to span the entire distance from the impingement wall (e.g., inner surface of the outer wall of a vane) to the confinement wall (i.e., shroud). This design may lower the vane material temperature because all of the cooling air in the flow channel is confined and forced through the fins. However, a significant pressure drop may occur in this scenario as the flow area is reduced. It may be desirable to create high velocity flow in the hottest regions of the flow channel and sacrifice extended surface area for heat transfer in the cooler regions.

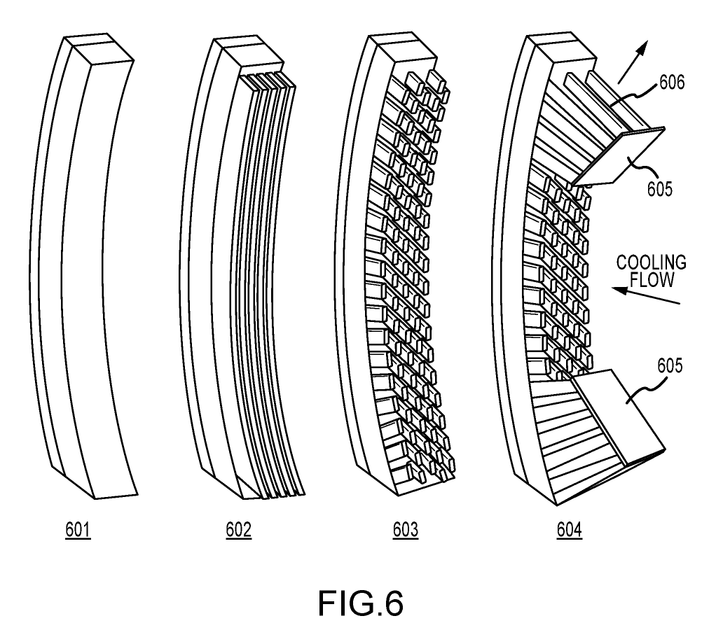

FIG. 6 shows a reference smooth surface 601 and exemplary embodiments of various micro-structured surfaces as they may appear on the curved interior surface of the outer wall of a vane: a micro-grooved surface 602, a micro-finned surface 603, and a micro-finned surface with a shroud 604. As shown, a shroud 605 may comprise a gap forming an impingement nozzle through which cooling air may enter the flow channel 606.

A micro-structured surface (e.g., surfaces 602, 603, 604) may provide a significantly greater amount of surface area as compared to a reference smooth surface of the same general size (e.g., surface 601). For example, a micro-finned surface may provide 5 times more surface area, 10 times more surface area, 20 times more surface area, etc. as compared to a smooth surface having the same overall height and width. As determined by simulation models, the total heat flux of an embodiment of a shrouded fin design similar to micro-finned surface with a shroud 604 was 2.19 times higher than a smooth surface impingement design such as reference smooth surface 601. This improvement may be attributable to the additional surface area provided and may translate directly into higher allowable combustor temperatures or a lesser volume of cooling air flow needed.

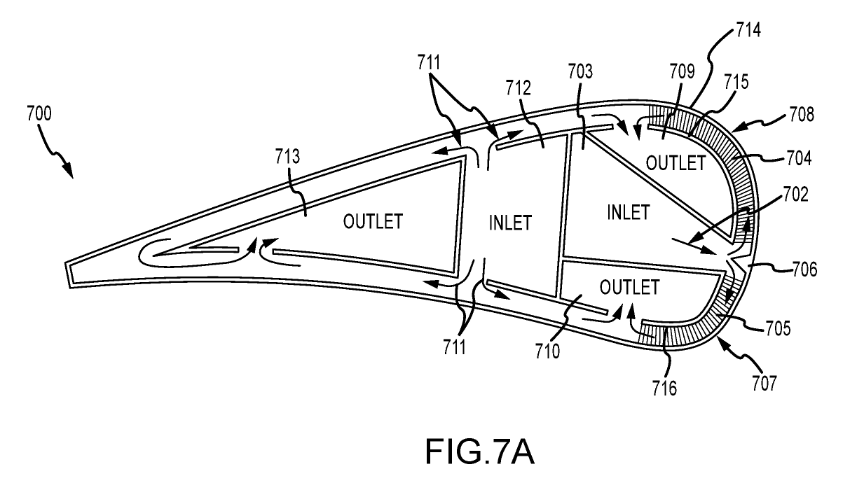

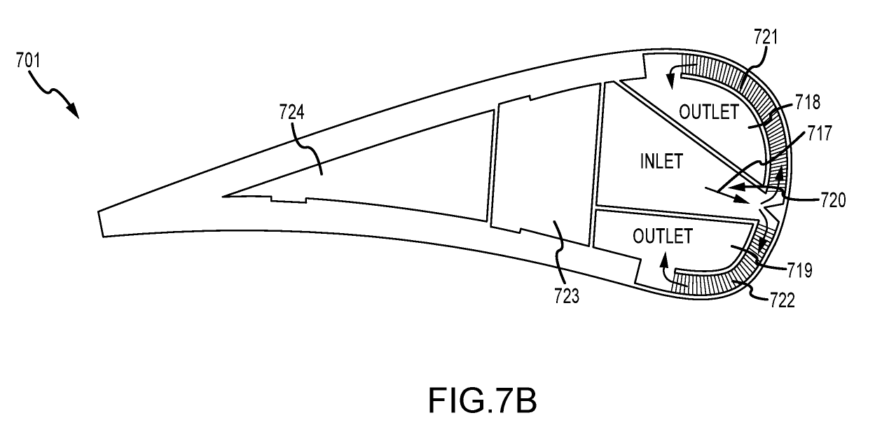

As previously discussed, embodiments of the presented inventions may include thin foils which may be stacked and bonded together to define a vane (or other gas turbine engine component). FIGS. 7A-7B show two example foil designs in order to illustrate the cooling air flow patterns through the vanes. FIG. 7A substantially resembles the foil illustrated in FIG. 4 but with the addition of a finned array(s) 704, 705 at the suction-side heating peak 708 and at the stagnation point 707. A foil may generally comprise a top surface disposed in a first plane and a bottom surface disposed in a second plane parallel to the first plane. The outer wall typically extends between the top surface and bottom surface. For first foil 700 (FIG. 7A), the leading edge cooling air 702 is fed from inlet plenum 703, is, in the illustrated embodiment, bifurcated by the wedge and flows through a finned array(s) disposed in flow channels 704, 705 on either side of the impingement point 706 (i.e., location where cooling air is introduced into the flow channel). In the illustrated embodiment, the flow channels are defined by the inner surface of the outer wall 714 and the outer surface of two inner walls 715, 716. The use of the bifurcated flow thereby cools both the stagnation region 707 and the suction-side heating peak region 708, and exits through the two leading edge outlet plenums 709, 710. It will be appreciated that in other embodiments, a single flow channel may pass over both the stagnation region and the suction-side heating peak. The inlet and outlet plenums 703, 709, 710 run the entire span of the vane, with cooling air 702 fed and returned to the cooling channels across the entire span. The remainder of the vane is cooled through the use of micro-channels only (e.g., flow channels without fins). The cooling air for the remainder of the vane 711 may be fed through inlet plenum 712, and it flows both forward to the leading edge outlet plenums 709, 710 and aft to the trailing edge outlet plenum 713. For second foil 701 (FIG. 7B), only the leading edge region may be cooled because no micro-channels exist aft of the finned regions. For the second foil 701, leading edge cooling air 717 may be fed from inlet plenum 720, flows through the finned arrays 721, 722, and exits through the two leading edge outlet plenums 718, 719. The aft inlet and outlet plenums 723, 724 do not participate in feeding or returning any cooling air from second foil 701, but rather provide internal passages for inlet air and outlet air flowing from adjacent first foils, e.g., first foil 700.

The flow channels are typically very narrow. For instance, the distance between the inside surface of the outer wall and the outside surface of the inner wall in the leading edge region is between about 0.8% to about 4.5% of the chord length of the blade. In one embodiment, this distance is constant throughout the entire leading edge region. Similar or identical distances are utilized between the outer and inner walls in the sidewall micro-channels as well. These distances were chosen as a good tradeoff between pressure drop and thermal performance. The smaller the spacing, the higher the flow velocity, which produces higher heat transfer coefficients, and thus more effective cooling. However, when going to smaller wall spacings, there is an increase in the pressure drop. The converse is true for larger wall spacings.

Foils may stacked in any appropriate order to provide a desired flow channel size, for example, a stack of foils may alternate between one first foil 700 and one second foil 701. Alternately, a stack of foils may comprise three first foils 700 alternated with three second foils 701. It should be appreciated that it may be desirable to provide flow channels along the leading edge of every foil to maximize cooling in that region while micro-channels adjacent to the suction-side wall and pressure-side wall may only be provided in some foils and not in others to produce a conduction fin effect in the sidewall regions and reduce the amount of cooling air circulated to that which is needed. It should be appreciated that more than two foil configurations (e.g., first foil 700 and second foil 701) may be used to construct a vane.

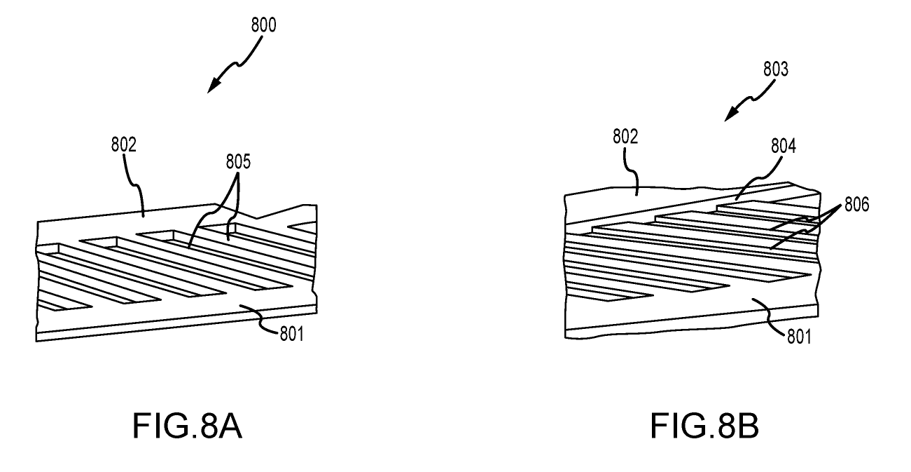

FIG. 8A illustrates a portion of a finned array 800 (e.g., as may be disposed in a portion of the leading edge region) having full-thickness fins 805 extending from the outer wall 801 to the inner wall 802 (e.g., shroud). Full-thickness fins may have a thickness equal to that of the foil in which they are disposed. In other words, a top surface of each fin may be coplanar with the top surface of the foil and a bottom surface of each fin may be coplanar with the bottom surface of the foil. In this embodiment, it should be appreciated that stacking a series of foils with full-thickness fins may cause the flow channel in this region of the foils to become blocked due to the stacked fins forming a solid wall. Therefore, fins on adjacent foils may be disposed in a laterally offset manner such that cooling air may serpentine between fins of adjacent foils. Alternatively or additionally, leading edge spacer foils without fins in this region (e.g., a foil shown for the vane 400 in FIG. 4) may be inserted between foils having full-thickness fins to provide a cooling air flow path through the leading edge cooling air flow channel.

As illustrated in FIG. 8B, a finned array 803 may have half-thickness fins 806. Although dubbed “half-thickness” fins, it should be appreciated that the fins need not have a thickness equal to one-half of the thickness of the foil in which they are disposed, but rather may have any thickness less than a thickness of the foil. In this regard, a top surface of each fin may not be coplanar with the top surface of the foil and/or a bottom surface of each fin may not be coplanar with the bottom surface of the foil. An offset 804 may exist on the top side of a fin, the bottom side of a fin, or both. In the exemplary configuration shown in FIG. 8B, the bottom surface of each fin is coplanar with the bottom surface of the foil and the top surface of each fin is not coplanar with the top surface of the foil. A stack of foils having half-thickness fins may be used without the need for leading edge spacer foils given the openings that would remain between adjacent stacked fins within the flow channel given the offset 804 of each fin.

Half-thickness fins may be formed by any appropriate means of construction including but not limited to laser-etching, chemical etching, mechanical grinding, 3D printing, etc. In an embodiment, the etching process may use a mixture that includes hydrochloric and/or nitric acid. Of note, in an embodiment of metal foils using Hastelloy X, it has been determined by the inventors that a process for etching which provides good etch quality with feature sizes on the order of those described herein may require a more aggressive chemical etchant than is typical for other metals and may require extra passes for shorter times through the etcher.

In the case of 0.002″ foil thicknesses, half-etching of the fins may yield an approximately 0.001″ thick fin. Tabs may be used along the side wall flow channels to support the internal structures such as the internal walls and may also be half-etched (tabs may also be used in the leading edge sections for full-thickness designs to support the internal structures). Tabs may only be needed during etching, stacking, and bonding of the foils because the internal structures may become bonded to the manifolds during bonding and receive support therefrom. If the tabs were not present prior to bonding, the internal structures of the vane would likely fall out or become misaligned during assembly. It is desirable to remove these tabs after bonding but this may not always be possible and, therefore, the tabs may remain inside a completed vane in some embodiments. In such instances, the location and shape of each tab may be designed such that they present minimal impact in terms of pressure drop and flow disturbance. In alternative manufacturing techniques such as 3D printing, these tabs may not be necessary and may be omitted.

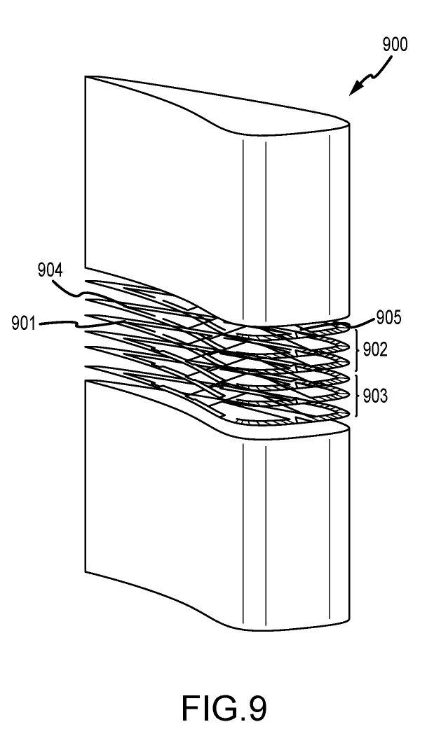

FIG. 9 shows an example of an assembly of foils stacked to produce a vane 900. The illustrated embodiment uses half-etched leading edge fins. In this design, there may be two staggered finned arrays at the leading edge (i.e., one foil has fins in a position where an adjacent foil does not) or, because the fins are half-etched, staggering may not be necessary. In the illustrated embodiment, the side wall micro-channels 901 are sized to be 0.006″ high in the spanwise direction. Therefore, using 0.002″ thick foils (although any appropriate thickness may be used), the foils may be stacked such that three foils in a row are foils with side wall micro-channels 902, followed by three foils in a row that do not have side wall micro-channels 903. The vane 900 may be fabricated by stacking foils in the order described over and over again until the final vane airfoil height is achieved. In the case of 0.002″ thick foils, a vane having a height of 2.4″, for example, may require approximately 1200 individual foils. Interior walls 905 and exterior walls 904 of each foil may be approximately 0.020″ thick to provide adequate strength and bond path through the span of the vane.

It should be noted that many of the illustrations provided in the figures depict a vane having a single cross-sectional profile. In other words, the shape of the outer perimeter of each foil may be identical. However, it should be appreciated that in many real-world implementations, nozzle guide vanes and other gas turbine engine components may be clocked or twisted such that moving in the spanwise direction, each cross-sectional profile may be unique. In this regard, a 2.4″ vane using 0.002″ foils may require up to 1200 unique foil patterns.

Alternatively to half-thickness fins, a vane may be constructed with full-thickness leading edge fins. In this design, at least two staggered finned arrays may be needed at the leading edge. However, as opposed to the half-etched version, full-thickness fins would have no spanwise space between the staggered fin layers if they were simply stacked in an A-B-A-B fashion. Therefore, a leading edge spacer foil may be needed to provide a sufficient cross-sectional area for air flow. Such a leading edge spacer foil may provide room for the cooling air to pass between layers of fins. Because of this additional type of leading edge design, as you travel in the spanwise direction, the leading edge fins may alternate in an A-C-B-C-A-C-B-C repeating pattern. In addition to the leading edge fin pattern, side wall micro-channels may be sized to be 0.006″ high in the spanwise direction. Using 0.002″ thick foils, the foils may be stacked as they were described in relation to the half-etched version with three foils in a row with side wall micro-channels, followed by three foils in a row that do not have side wall micro-channels (i.e., side wall spacer foils).

The process for stacking the foils may include using alignment pins. The tight tolerance of these pins, along with a combination of etched circular and elongated holes in each foil, may allow the features on each successively stacked foil to be precisely aligned. The stacking fixture used to hold the stack of foils may be inserted into a bonding fixture. As an example, a bonding fixture may consist of two molybdenum platens connected with molybdenum threaded rods. The bonding fixture may then be placed in a vacuum furnace and ramped to 2100° F. for several hours. Due to the thermal expansion mismatch, the foil may expand at a greater rate than the molybdenum bonding fixture initially. This may help ensure the foils are in intimate contact, enabling good diffusion bond strength. Due to a minute amount of variance in the thicknesses of the foils, and due to the presence of some amount of “crush” experienced during the bonding phase (e.g., about 1.25%), an additional amount of foil may be stacked to account for this while still hitting a target vane length.

Following bonding of the foils, the vanes may be removed from the bonded stack through wire electrical discharge machining (EDM). This may consist of an electrified wire which produces a series of rapidly recurring current discharges between the wire and the part being machined, effectively burning away a small amount of material with each spark.

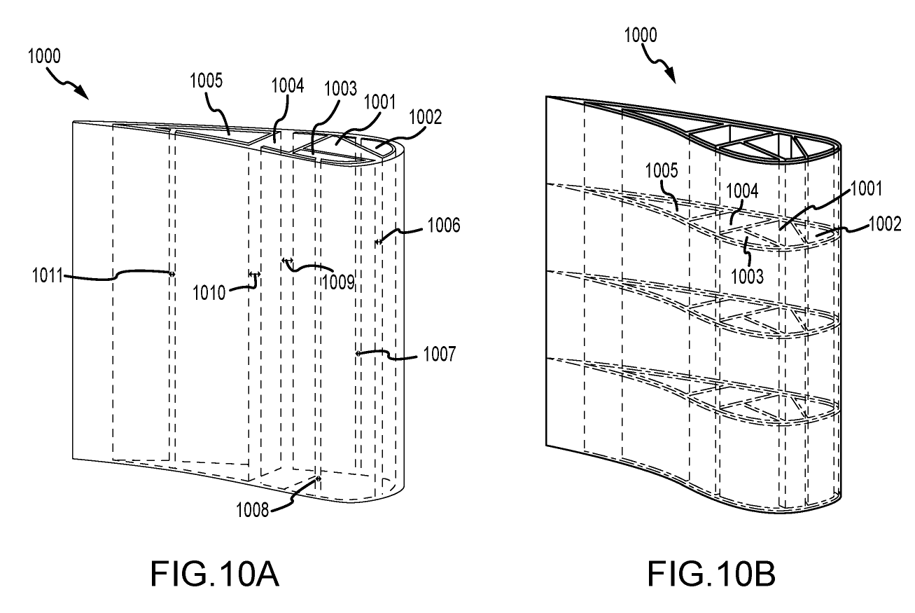

FIGS. 10A-10B show the internal passages (e.g., inlet and outlet plenums, micro-channels, flow channels, etc.) within a stacked and bonded foil vane 1000. More specifically, FIG. 10A illustrates interfaces between air distribution plenums and micro-channels and flow channels. As can be seen, when each foil in a stack has an opening between an inlet plenum or outlet plenum and a micro-channel or flow channel (e.g., the impingement nozzle forming slot 1006), there is a slot or linear opening formed running longitudinally along the spanwise direction of the vane. For example, slot 1006 permits entry of cooling air from inlet plenum 1001 into the leading edge flow channel(s). As discussed in relation to FIG. 4, this cooling air flow may be bifurcated with a portion of this cooling air moving toward the suction-side and a portion moving toward the pressure-side. The heated cooling air may pass through slot 1007 into outlet plenum 1002 and through slot 1008 into outlet plenum 1003. Similarly, cooling air may circulate from inlet plenum 1004 through slots 1009, 1010 toward slots 1007, 1008 and also toward slot 1011 and into outlet plenum 1005. It should be appreciated that the embodiment shown in FIG. 10A does not include side wall spacer foils (e.g., foil 701 of FIG. 7B). In other words, each foil used in the vane 1000 shown includes side wall micro-channels. In the event that side wall spacer foils are used, or other types of foils not having side wall micro-channels, slots 1009, 1010, and 1011 would not run the entire spanwise length of the vane 1000 but rather would appear broken at the locations pertaining to such side wall spacer foils.

FIG. 10B depicts cross-sections of vane 1000 at various locations and is intended to illustrate that the inlet plenums 1001, 1004 and outlet plenums 1002, 1003, 1005 run longitudinally through the vane 1000 in the spanwise direction.

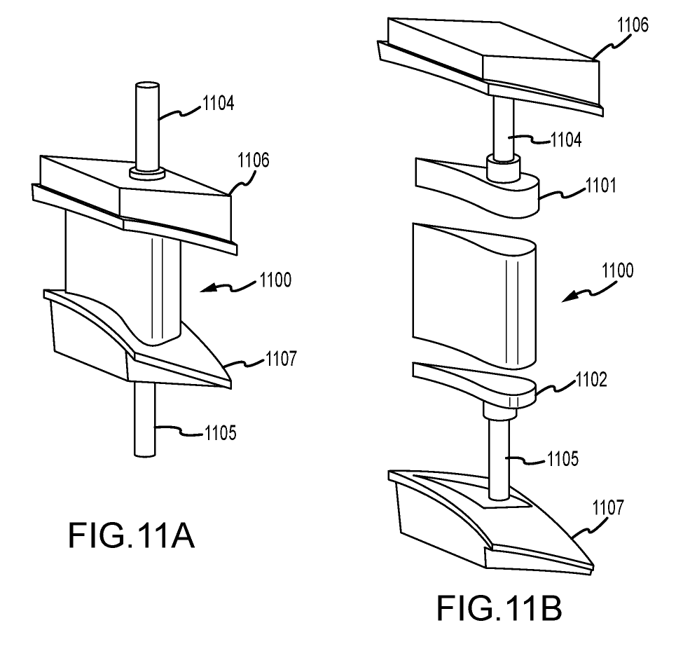

FIGS. 11A (assembled view) and 11B (exploded view) illustrate an embodiment of a vane 1100 as it may be attached to an outer manifold 1101 and an inner manifold 1102. The inner and outer manifolds 1102, 1101 may be disposed within inner and outer shrouds 1107, 1106 respectively. In this embodiment, cooling air is circulated into the inner manifold 1102 through one or more inlet lines 1105. The manifold distributes the cooling air into one or more inlet plenums of the vane 1100 (e.g., inlet plenums 1001, 1004 of FIG. 10A). The cooling air may be circulated through micro-channels and/or flow channels and across one or more finned arrays inside the vane, acquiring heat as it passes through and into one or more outlet plenums (e.g., outlet plenums 1002, 1003, 1005 of FIG. 10A). Outer manifold 1101 collects the heated cooling air from the outlet plenums and channels it into one or more outlet lines 1104.

In an embodiment, a plurality of inner manifolds and/or a plurality of outer manifolds may be fluidly interconnected such that a single manifold is operative to feed or collect cooling air to or from a plurality of vanes. In another embodiment, only a single manifold may be used on a vane such that an inlet line and an outlet line extend from the same manifold. It should be noted that although the terms “cooling air” and “air” are used herein to describe the fluid circulated through a turbine component for cooling, it should be appreciated that any suitable cooling fluid may be utilized. Particularly in the case of a cooling system in which the cooling fluid is not dumped into the core flow of the engine but is returned through an outlet line, alternative cooling fluids may be used in place of cooling air. In such an instance, cooling fluid may be supplied from a reservoir rather than fed from the compressor. It should also be appreciated that although shown as separate components in FIGS. 11A and 11B, a vane, a manifold, a shroud, an inlet line, an outlet line, or any combination thereof may be constructed as a single component. Additionally or alternatively, rather than being constructed as distinct components, a manifold and associated inlet/outlet lines may be incorporated into other engine components such as a shroud, housing, blade platform, or spindle.

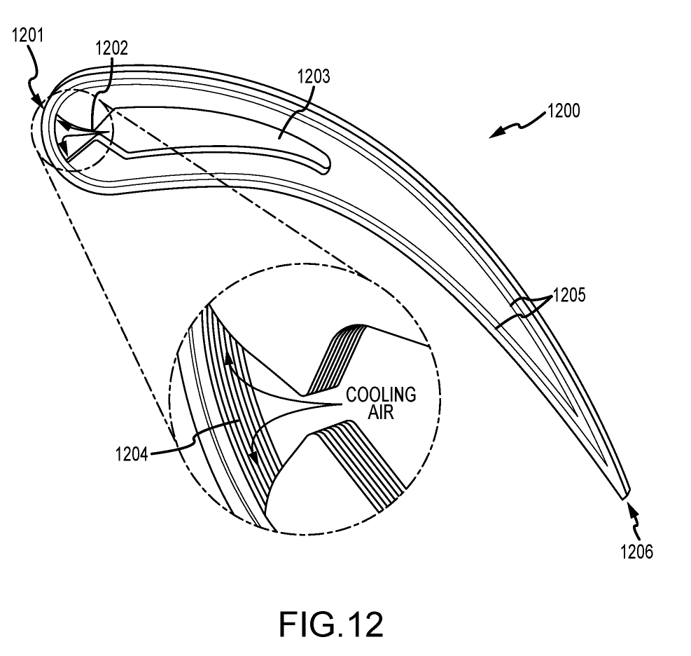

FIG. 12 illustrates an embodiment of a vane 1200 that uses an impingement scheme with a micro-structured surface (shown as groves but could be fins, micro-texturing, etc.) on the interior wall in the leading edge region 1201. Cooling air exits the nozzle 1202 from the inlet plenum 1203, impinges in the micro-structured region 1204, and then exits via the micro-channels 1205. The flow through the micro-channels 1205 cools the side walls as it travels along the pressure-side and suction-side surfaces. The heated cooling air may be exhausted from a port along the trailing edge 1206 and dumped into the core flow of the engine. Though the heated cooling air is dumped into the core flow, the mass flow of the cooling air may be reduced in comparison to prior art bleed air systems reducing efficiency penalties.

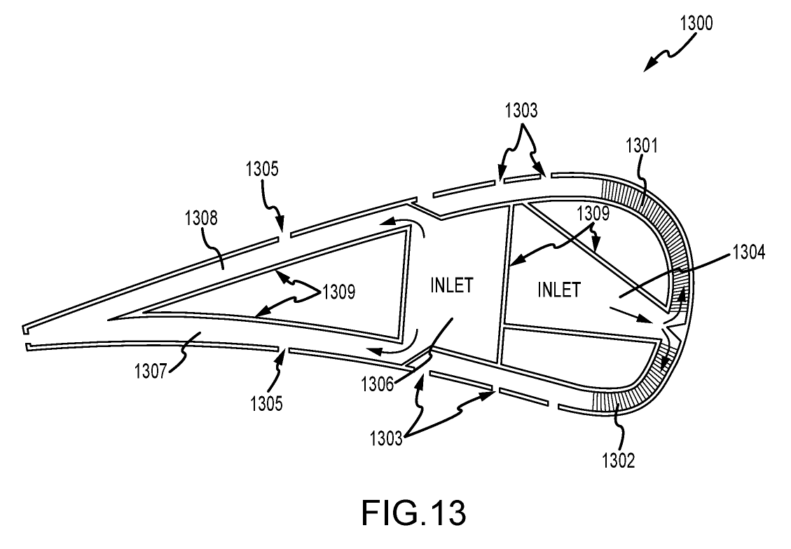

FIG. 13 illustrates a foil configuration for a vane 1300 similar to that of FIG. 7A. However, in the illustrated embodiment, heated cooling air is exhausted out of the vane 1300 through film-cooling exhaust ports 1303, 1305. In this regard, cooling air may enter the vane through inlet plenum 1304, circulate through flow channels 1301, 1302, and exit through the leading edge exhaust ports 1303. Similarly, cooling air may enter the vane 1300 through inlet plenum 1306, circulate through micro-channels 1307, 1308, and exit through side wall exhaust ports 1305. In the illustrated embodiment, no outlet plenums are provided but rather the heated cooling air exits the vane 1300 only through the exhaust ports 1303, 1305. In this embodiment, internal walls 1309 may nonetheless be provided to direct impingement cooling air flow, to define the leading edge flow channel, side wall micro-channels, and to provide structural support to the vane. It should be appreciated that in another embodiment a portion of the cooling air may exit through film-cooling exhaust ports and the remainder of the cooling air may exit through at least one outlet plenum so as to avoid dumping a portion of the cooling air into the core flow.

Testing conducted using inventive features described herein indicated an increase in the turbine inlet temperature of a gas turbine engine of 345° F. or more above current operating conditions. The result of this improvement may be harnessed by either reducing the cooling air flow rate and keeping the turbine inlet temperature constant, thereby reducing the cycle losses from pulling air off the high compressor outlet, or by keeping the cooling air flow rate constant and increasing the turbine inlet temperature, thereby increasing the power and cycle efficiency.

The foregoing description of the presented inventions has been presented for purposes of illustration and description. Furthermore, the description is not intended to limit the inventions to the forms disclosed herein. Consequently, variations and modifications commensurate with the above teachings, and skill and knowledge of the relevant art, are within the scope of the presented inventions. The embodiments described hereinabove are further intended to explain known modes of practicing the invention and to enable others skilled in the art to utilize the inventions in such or other embodiments and with various modifications required by the particular application(s) or use(s) of the presented inventions. It is intended that the appended claims be construed to include alternative embodiments to the extent permitted by the prior art.

What is claimed is:

1. An air impingement cooled turbine vane, having a plurality of stacked and bonded metal foils defining the turbine vane, the turbine vane having an internal air inlet plenum for receiving an inlet airflow into the turbine vane, at least a first foil of the stacked and bonded metal foils, comprising:
an outer wall having an airfoil shape with a leading edge region, a pressure-side, a suction-side and a trailing edge, wherein said pressure-side and said suction-side extend between said leading edge region and said trailing edge;
at least a first inner wall spaced from an inside surface of said outer wall and extending along at least a portion of said leading edge region including a stagnation point of the turbine vane for said first foil, wherein said inside surface of said outer wall and an outside surface of said first inner wall at least partially define a first flow channel therebetween; and
a plurality of micro-structures extending from said inside surface of said outer wall into said flow channel, wherein air from said internal air inlet plenum passes into a first inlet of said first flow channel and across said plurality of micro-structures.

2. The turbine vane of claim 1, wherein said plurality of micro-structures are integrally formed with said inside surface of said outer wall within said first flow channel.

3. The turbine vane of claim 2, wherein a combined surface area of said inside surface of said outer wall within said flow channel and said plurality of micro-structures is at least ten (10) times a surface area of a reference inside surface of said outer wall within said first flow channel without said plurality of micro-structures.

4. The turbine vane of claim 3, wherein said total surface area of said inside surface and said plurality of micro-structures is at least at least twenty (20) times a surface area of the reference inside surface without said plurality of micro-structures.

5. The turbine vane of claim 2, wherein said plurality of micro-structures comprise a plurality of fins each having a first end connected to said inside surface of said outer wall.

6. The turbine vane of claim 4, wherein said plurality of fins each have a second end connected to said outside surface of said inner wall.

7. The turbine vane of claim 4, wherein said fins have a thickness that is less than a thickness of said first foil having said outer wall.

8. The turbine vane of claim 1, wherein said inner wall is spaced from said outer wall a distance that is between about 0.5% and about 5% of a chord length of the first foil as measured between the stagnation point and the trailing edge.

9. The turbine vane of claim 1, wherein the turbine vane further comprises:
an internal air outlet plenum for exhausting airflow out of the turbine vane, wherein air passing out of an outlet of the flow channel passes into the air outlet plenum.

10. The turbine vane of claim 1, wherein said outer wall further comprises:
at least a first bleed port extending through said outer wall, wherein at least a portion of air passing out of an outlet of the flow channel passes out of said bleed port.

11. The turbine vane of claim 1, further comprising:
at least a second inner wall spaced from an inside surface of said outer wall and extending along at least a portion of one of said suction-side and said pressure-side, wherein said inside surface of said outer wall and an outside surface of said second inner wall at least partially define a second flow channel therebetween and wherein air from the internal air inlet plenum passes into a second inlet of said second flow channel.

12. The turbine vane of claim 1, further comprising:
at least a second foil of the stacked and bonded metal foils, including an outer wall having a substantially similar airfoil shape, wherein the second foil has a planar top or bottom surface bonded to a planer top or bottom surface of said first foil, wherein said first foil and said second foil collectively define said first flow channel.

13. The turbine vane of claim 1, wherein said first inlet is disposed between first and second ends of said inner wall, wherein a first portion of air passing into said first inlet passes through said first flow channel in a first direction and a second portion of the air passing into said first inlet passes through said first flow channel in a second direction.

14. A vane configured for use in a turbine engine, comprising:
a housing, wherein said housing extends longitudinally along a first axis and is airfoil-shaped to receive combustion air flow travelling in a direction substantially transverse to the first axis at a leading edge and divert a portion of the combustion air flow around a suction-side of the housing and another portion of the combustion air flow around a pressure-side of the housing, and wherein the housing has an internal core comprising a network of cooling air flow channels defined by a plurality of walls;
an inlet configured to route cooling air into the internal core;
an outlet configured to route heated cooling air from the internal core; and
an impingement channel configured to receive cooling air from the inlet and direct at least a portion of said cooling air across a plurality of micro-structures disposed in said impingement channel, wherein each of said plurality of micro-structures is disposed upon an internal side of a portion of an external wall of said housing defining an outer wall of said impingement channel.

15. The vane of claim 14, wherein the portion of the external wall of said housing comprises at least a portion of the leading edge.

16. The vane of claim 15, wherein the plurality of micro-structures comprises a plurality of fins, each fin having a nominal thickness in a direction transverse to a direction of cooling air flow through the impingement channel.

17. The vane of claim 16, wherein each of the plurality of fins is secured to an internal shroud at an end of each fin opposite an end secured to the internal side of the external wall, said internal shroud defining an inner wall of said impingement channel.

18. The vane of claim 17, wherein the vane comprises a plurality of metallic foils stacked in a direction of the first axis, said plurality of metallic foils secured in a bonded configuration such that a portion of each foil comprises a portion of the network of cooling air flow channels.

19. The vane of claim 18, wherein at least two adjacent metallic foils comprise fins, wherein a maximum thickness of said fins is less than a thickness of said metallic foils.

20. The vane of claim 19, wherein the thickness of said metallic foils is approximately 0.002″.

21. The vane of claim 18, wherein a first of two adjacent metallic foils comprises fins in an area of the first metallic foil corresponding to the leading edge, said fins having a maximum thickness equal to a maximum thickness of said first metallic foil, and a second of said two adjacent metallic foils comprises a void in an area of said second metallic foil corresponding to the leading edge, wherein cooling air may pass through said void adjacent to said fins when said two adjacent metallic foils are disposed in the bonded configuration.
